(19) United States
(12) Patent Application Publication
(10) Pub. No.: US 2012/0197828 A1
(43) Pub. Date: Aug. 2, 2012

(54) Energy Saving Control for Data Center

(75) Inventor: Ming Yi, Wuhan (CN)

(73) Assignee: INTERNATIONAL BUSINESS MACHINES CORPORATION, Armonk, NY (US)

(21) Appl. No.: 13/358,225

(22) Filed: Jan. 25, 2012

(30) Foreign Application Priority Data
Jan. 27, 2011 (CN) 201110029732

(51) Int. Cl. G05F 5/00; G05D 7/06; G06F 15/18

(52) U.S. Cl. 706/12; 700/291

(57) ABSTRACT

A data center includes at least one rack containing electronic devices, a data center air conditioning system (DCAC), and an environmental parameter monitoring system. At least one set of eligible environmental parameters is determined that satisfies the cooling demand of the at least one rack containing electronic devices. According to the at least one set of eligible environmental parameters and corresponding relationships between sets of setting parameters of the DCAC and corresponding sets of environmental parameters determined by an artificial neural network, plural sets of setting parameters of the DCAC are determined. A power consumption of the DCAC to which each set of setting parameters in the plural sets of setting parameters corresponds is obtained. A set of setting parameters for which the corresponding power consumption satisfies a predetermined condition for energy saving is selected and us to set the DCAC.

### 1. FIELD OF THE INVENTION

The present invention relates to data centers, and more particularly, to energy savings in a data center.

### 2. DESCRIPTION OF THE RELATED ART

A data center refers to such a room or building facility in which IT and network devices (e.g., servers) are deployed on a group of aligned racks. Data centers usually consume large amount of electric power. For example, in 2006, the electric power consumed by data centers in the United States was about 1.5% of the total national power generation. In order to reduce electric power consumption in data centers, many methods have been considered.

One method is to make corresponding adjustments to the cooling of the data center air conditioning system (DCAC) by detecting the temperature of the return air to make the temperature of the return air as high as possible under the precondition of satisfying the cooling demand in order to reduce the electric power consumed by the air conditioner. However, because the temperature of the return air is the inter-influenced result by the heat dissipation of the electronic devices in the racks of the entire data center, adjusting the cooling of DCAC by detecting the temperature of the return air cannot guarantee the requirements for the temperature and air flow in each individual rack.

Another method is to numerically solve, by using the method of numerical analysis, the relation among the temperature distribution and air flow distribution of the data center and DCAC settings and server load distribution and to calculate DCAC settings that meet the temperature and air flow demands at each rack with the minimum power consumption based on the current specific server load distribution. However, this method is computing intensive and time consuming, and thus can not be used to set DCAC in real time in response to momentary changes of the server loads.

### SUMMARY OF THE INVENTION

According to an aspect of the present invention, a data center includes at least one rack containing electronic devices, a DCAC and an environmental parameter monitoring system. A control method includes: determining at least one set of eligible environmental parameters that can satisfy the cooling demand of the at least one rack containing electronic devices; according to the at least one set of eligible environmental parameters and the corresponding relationships between sets of setting parameters of DCAC(s) and corresponding sets of environmental parameters, determining plural sets of setting parameters of DCAC(s), wherein the corresponding relationships are corresponding relationships based on an artificial neural network; obtaining the power consumptions of DCAC to which the plural sets of setting parameters of DCAC(s) correspond; and selecting a set of setting parameters of which the corresponding power consumption satisfies a predetermined condition for energy saving, and using the set of setting parameters to set the computer room air conditioning system.

According to another aspect of the present invention, a data center includes at least one rack containing electronic devices, a DCAC and an environmental parameter monitoring system. An energy control system for the data center includes eligible environmental parameter determining component configured to determine at least one set of eligible environmental parameters that satisfy the cooling demand of the at least one rack containing electronic devices; an air conditioner setting parameter determining component configured to, according to the at least one set of eligible environmental parameters and the corresponding relationships between sets of setting parameters of DCAC(s) and corresponding sets of environmental parameters, determine plural sets of setting parameters of DCAC(s), wherein the corresponding relationships are corresponding relationships based on an artificial neural network; an air conditioner power consumption obtaining component configured to obtain the power consumptions of DCAC(s) to which the plural sets of setting parameters of DCAC(s) correspond; and a settings component configured to select a set of setting parameters of which the corresponding power consumption satisfies a predetermined condition for energy saving and to install the setting parameters on DCAC(s).

The described embodiments adjust in response to current server loads and environment factors (e.g., temperature, etc.) and act to reduce data center energy consumption, realizing real-time and effective energy saving control of the data center.

### BRIEF DESCRIPTION OF THE DRAWINGS

FIG. 1 illustrates a plan view of an exemplary data center according to one embodiment;

FIG. 2 depicts an data center energy control system according to one embodiment;

FIG. 3 illustrates an artificial neural network according to embodiment; and

FIG. 4 is a high level logical flowchart of an exemplary data center energy control method according to one embodiment.

### DETAILED DESCRIPTION

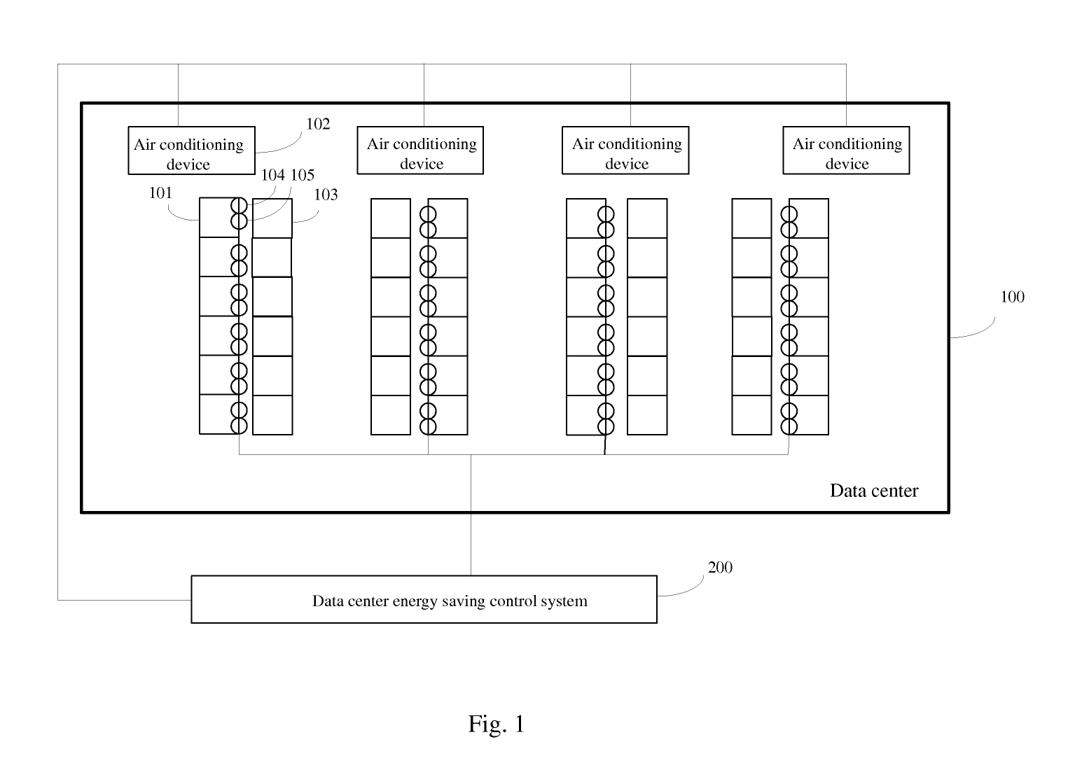

With reference now to FIG. 1, a plan view of an exemplary data center is illustrated. As shown, data center 100 includes a plurality of racks 101. Each rack 101 may contain multiple electronic devices (e.g., servers, routers, disk drives, displays, etc.) for executing various electronic functions like computing, switching, routing and displaying. Racks 101 are usually aligned regularly according to industry standards. Racks 101 are usually placed on a raised floor, and a ventilation device 103, like ventilation floor board, is provided on the floor beside racks 101.

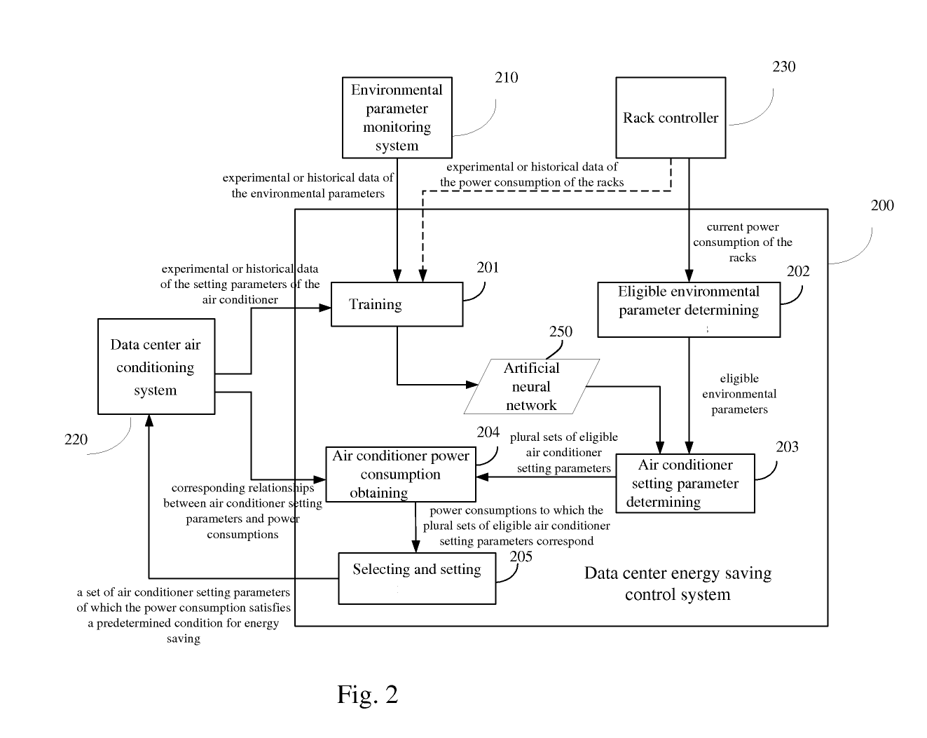

Data center 100 further includes one or more air conditioning devices 102 illustrated individually in FIG. 1, but collectively depicted as a data center air conditioning system (DCAC) 220 in FIG. 2. The cold air supplied by DCAC is transmitted close to racks 101 through the space under the raised floor and the ventilation device 103 and passes through racks 101 to cool electronic devices in racks 101. Heated air from racks 101 flows back to the air conditioning devices 102 through the room space. Parameters like the temperature and flow rate of the cold air supplied by each of the air conditioning devices 102 are adjustable. The adjustment of the air conditioning device parameters can be performed manually, or alternatively, by automatically executing data processing commands for adjusting the parameters.

Data center 100 is further provided with an environmental parameter monitoring system 210 (see, e.g., FIG. 2) for monitoring environmental parameters like temperatures and air flows. For example, a temperature sensor 104 and an air flow sensor 105 are provided at the inlet of each rack for detecting the air temperature and air flow amount or air flow speed at the inlet of the rack, respectively. Other sensors, e.g., a barometric pressure sensor, a humidity sensor, etc., can also be provided at the inlet of each rack to detect parameters like the barometric pressure and humidity at the inlet of the rack, respectively. In addition, at other locations of the data center, e.g., at the air inlet of the air conditioning device, sensors of temperature, air flow, etc. may also be provided. The sensors in the data center can be connected by devices like cables and sensor hub to form a sensor network. The sensor network is also connected with the data center energy saving control system 200 (e.g., via cables) in order to transmit data like the monitored temperatures, air flows to the data center energy saving control system 200 for processing. Interconnecting the sensors and connecting the sensors with data center energy saving control system 200 in a wired manner can avoid signal interference between the data transmitted by the sensors and data stored and processed in the electronic devices and improve reliability of data transmission and processing. Of course, the sensors can also be interconnected and the sensors can also be connected with the data center energy saving control system 200 in a wireless manner. Environmental parameter monitoring system 210 can be an existing environmental parameter monitoring system, e.g., the Measurement and Management Technology of IBM Corporation or the wireless sensor network of SynapSense Corporation. Though in the above description, environmental parameter monitoring system 210 is considered as outside the data center energy control system 200, environmental parameter monitoring system 210 can also be considered as included within data center energy saving control system 200.

As further shown in FIG. 1, data center energy saving control system 200 is connected with DCAC via cables or in a wireless manner to set the parameters of air conditioning devices 102 in DCAC.

Referring now to FIG. 2, a embodiment of data center energy saving control system 200 will be described. Data center energy saving control system 200 can be implemented in a computer system, e.g., implemented in the software executed from data storage by a processor of the computer system. The computer system may be within data center 100 or outside data center 100. Data center energy saving control system 200 can be connected with environmental parameter monitoring system 210 within the data center to receive and to process environmental parameters like air temperature, air flow amount or air flow speed received from environmental parameter monitoring system 210. As noted above, environmental parameter monitoring system 210 comprises sensors such as temperature sensors 104 and air flow sensors 105 depicted in FIG. 1. Data center energy saving control system 200 can also be connected with DCAC 220 of data center 100 to set the settable parameters of DCAC 220, e.g., the outlet temperature, fan speed, etc. Data center energy saving control system 200 can also be connected with racks 101 or a rack controller 230 in data center 100 to obtain data like the power consumptions of the electronic devices housed in racks 101. Rack controller 230 can be any existing rack controller or components having similar functions. The connection between data center energy saving control system 200 and environmental parameter monitoring system 210, DCAC 220, and racks 101 or rack controller 230 can be realized by Ethernet or RS485, RS232, LonWorks, etc.

As shown in FIG. 2, data center energy saving control system 200 comprises a training component 201, eligible environmental parameter determining component 202, air conditioner setting parameter determining component 203, air conditioner power consumption obtaining component 204, and selecting and setting component 205.

According to some embodiments, training component 201 is configured to train an artificial neural network 250 by using experimental data or historical data of a set of setting parameters of DCAC 220 as the input data and using corresponding experimental data or historical data of a set of environmental parameters monitored by environmental parameter monitoring system 210 as the output data.

According to some other embodiments of the present invention, training component 201 is configured to train artificial neural network 250 by using experimental data or historical data of a set of environmental parameters monitored by the environmental parameter monitoring system 210 as the input data and using corresponding experimental data or historical data of a set of setting parameters of DCAC 220 as the output data.

Of course, in some embodiments of the present invention, training component 201 can also be considered as a separate module outside data center energy saving control system 200. That is to say, data center energy saving control system 200 may exclude training component 201 in some embodiments.

Artificial neural network 250 is a data model or computational model simulating the information processing of a biological neural network, and is a very powerful tool to solve non-linear statistical data modeling problems in a very short time. It is usually used to model complex relationships between inputs and outputs, or used to discover patterns in data, and thus is suitable for solving the energy saving problem in a data center environment.

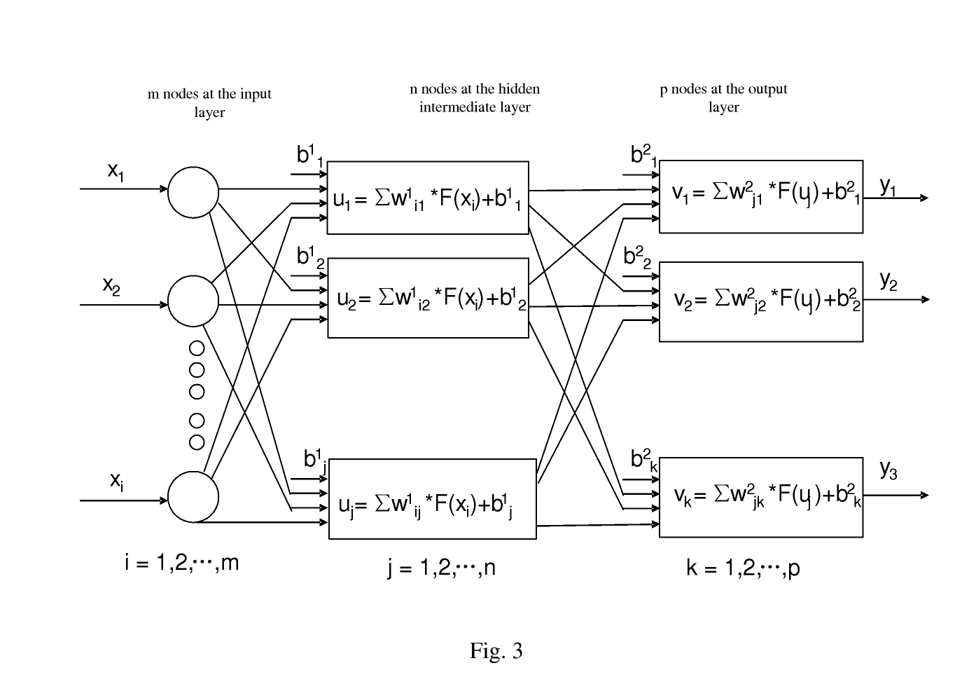

FIG. 3 schematically shows a typical algorithm structure of artificial neural network 250, which can be implemented, for example, in software. Artificial neural network includes an input layer, an output layer, and one or more hidden intermediate layers. The input layer includes a number of input nodes, also referred to as neurons. An input vector of independent variables are input into the input nodes in the input layer. The output layer includes a number of output nodes, which output an output vector as dependent variables. Each intermediate layer also includes a number of nodes. The intermediate layers connect the input layer with the output layer and allow complex and non-linear interactions between the inputs to generate the required output. Computations are performed at the intermediate layers and output layer, not at the input layer. All the interactions are performed in the direction from the input layer to the output layer, i.e., feed forward. Therefore, artificial neural network 250 can be represented as:

$${y}_{j}^{l} = ( {\sum }_{i = 1}^{{N}_{l - 1}} {w}_{ij}^{l} F ( {y}_{i}^{l - 1} ) + {b}_{j}^{l} ) \qquad ( 1 )$$

wherein, yⱼ^{l} denotes the output of the j^{th} node at the l^{th} layer, wᵢⱼ^{l} is a weight on the connection from the i^{th} node at the (l−1)^{th} layer to the j^{th} node at the l^{th} layer; bⱼ^{l} is a bias associated with the j^{th} node at the l^{th} layer; Nₗ₋₁ is the number of the nodes at the (l−1)^{th} layer. yⱼ⁰=xⱼ, wherein xⱼ is the j^{th} input and N₀ is the number of the inputs. F is an activation function, and can be considered as providing a non-linear gain for the nodes. Typically, F is the Sigmoid function shown as follows:

F(u)=1/(1+e^{-u}) (2)

This function limits the output of any node in artificial neural network 250 and allows artificial neural network 250 to process not only signals of small magnitude, but also signals of large magnitude.

It should be pointed out is that the embodiment of artificial neural network 250 shown in FIG. 3 includes only one hidden intermediate layer, and the output yⱼ¹ of the nodes of its intermediate layer and the output yⱼ² of the nodes of its output layer are denoted by uⱼ and vⱼ, respectively.

In the above equation (1), weights wᵢⱼ^{l} and bⱼ^{l} are both adjustable variables. The power of artificial neural network 250 lies in the following theorem: given sufficient number of hidden neurons, the function represented by the artificial neural network can approach any non-linear function to arbitrary accuracy in a finite domain. The process of using known input and output data to adjust an artificial neural network is called training the artificial neural network. Training artificial neural network 250 starts with a random number of nodes at the intermediate layer and with a random weight and bias of each node, uses known input and output data as training data, and then continuously adjusts the number of the intermediate layers, the number of nodes of the intermediate layers, and the weights and biases of the nodes until a required degree of accuracy is obtained. This is a process of learning. Once trained, artificial neural network 250 represents the relation between inputs and outputs and can be used to calculate corresponding and unknown current outputs or inputs according to the known current inputs or outputs. An existing algorithm for training the artificial neural network, known as back-propagation, is a powerful training algorithm and can guarantee that the artificial neural network will converge to match its training data.

According to some embodiments of the present invention, the training component 201 trains artificial neural network 250 by obtaining experimental data or historical data of a set of setting parameters of DCAC 220 (e.g., experimental data or historical data of the set temperature and air flow volume of DCAC) and uses them as the input data of artificial neural network 250, and by obtaining experimental data or historical data of a set of environmental parameters monitored by the environmental parameter monitoring system 210 and corresponding to the setting parameters of DCAC 220 (e.g., monitored environment temperature and air flow speed under specific set temperature and air flow volume of DCAC 220) and uses them as the output data of the artificial neural network. That is, the input of artificial neural network 250 includes a set of setting parameters of DCAC 220 (e.g., set temperatures and air flow volumes) and its output include a set of environmental parameters (e.g., environment temperature and air flow speed) monitored by environmental parameter monitoring system 210. As those skilled in the art will appreciate, the air flow volume of DCAC 220 can also be replaced by parameters like the rotational speeds of the air-supply fans of air conditioners 102.

The input data and output data for training artificial neural network 250 can either come from historical data gathered in running data center 100 or come from experimental data obtained while performing experimental operations on data center 100 for the purpose of training artificial neural network 250. While experimental operations are performed on data center 100, the whole range of all the possible values of each setting parameter of each air conditioning device in DCAC 220 may be traversed, and the environmental parameters under each set of value combinations of air conditioning devices 102 may be monitored to obtain more comprehensive input data and output data.

In addition, the input data and output data for training artificial neural network 250 can also come from the theoretical input and output data obtained by creating a numerical analysis model on the air flow of data center 100 and applying the data analysis model.

Since DCAC 220 usually includes multiple air conditioning devices 102, each air conditioning device 102 includes multiple adjustable setting parameters, and each setting parameter of each air conditioning device will have different influence on the environmental parameters monitored by the environmental parameter monitoring system 210, training component 201 may use each setting parameter of each air conditioning device 102 as an input of artificial neural network 250. For example, if n air conditioning devices are in data center 100 and each air conditioning device 102 has m settable parameters, there will be n×m inputs.

According to an embodiment of the present invention, environmental parameter monitoring system 210 includes sensors like a temperature sensor and an air flow sensor at the inlet of each rack 101. Thus, training component 210 can obtain environmental parameters like the temperature and air flow data at the inlet of each rack 101, and can use each environmental parameter at the inlet of each rack 101 as an output of artificial neural network 250. For example, if n racks are in the data center and there are m environmental parameters at each rack, n×m outputs can be obtained. In addition, other sensors can be provided at other locations in data center 100, and the training component 201 can also use the monitored data of the other sensors as the output of artificial neural network 250. Of course, training component 201 can also use the environmental parameters monitored by part of the sensors at part of the racks 101 or other locations as the output of artificial neural network 250.

Alternatively, according to some other embodiments of the present invention, training component 201 trains artificial neural network 250 by obtaining experimental data or historical data of a set of environmental parameters monitored by the environmental parameter monitoring system 210 and corresponding to DCAC 220 (e.g., the monitored environmental temperature and air flow speed under specific set temperatures and air flow volumes of DCAC 220) to use as the input data of artificial neural network 250, and by obtaining experimental data or historical data of the set of setting parameters of DCAC 220 (e.g., experimental or historical data of set temperatures and air flow volumes of DCAC 220) to use as the output data of artificial neural network 250.

According to an embodiment of the present invention, training component 201 can also use experimental data or historical data of the power consumption of each rack 101 (i.e., the total power consumption of all the electronic devices contained in the rack) of data center 100 as a setting parameter for training artificial neural network 250. That is, besides the setting parameters of DCAC 220, the input of artificial neural network 250 further includes the power consumption of each rack 101 of data center 100. The power consumption can also be used as the output of artificial neural network 250. Training component 201 can obtain the power consumption of each electronic device from the electronic device in the rack 101 or from a device, e.g., a rack controller 230, provided on the rack 101 for detecting the power consumption of the electronic devices in the rack.

It should be noted that the power consumption of the electronic devices in each rack 101 does not directly affect the temperature of the return air of DCAC 220. When cold air passes through a rack 101 and is heated, the heated air will mix with air heated by other racks 101 and eventually return to the inlets of DCAC 220. The temperature of the return air of DCAC 220 thus reflects the aggregate effect of heating by racks 101 and can be used to determine settings of DCAC 220. Therefore, the total power consumption of a row of racks 101 or an area of racks 101 (up to the entire data center 100) can be used to replace the power consumption of a single rack 101, as the input of artificial neural network 250. In this way, the number of the inputs of artificial neural network 250 may be reduced, and thus the training and calculation cost is also reduced.

According to another aspect of the present invention, training component 201 can also use historical data of the atmospheric temperature as the environmental parameter for training artificial neural network 250. That is, the input of artificial neural network 250 can include, besides the setting parameters of DCAC 220 (and possibly, the power consumptions of racks 101), atmospheric temperature. Atmospheric temperature can also be used as the output of artificial neural network 250.

According to other embodiments of the present invention, training component 201 can also use historical data or experimental data of other parameters as the input output data for training artificial neural network 250. That is, the input or output of artificial neural network 250 can also include other parameters. The other parameters can include, e.g., atmospheric humidity, barometric pressure, angle of sunlight, time of day, etc. As known by those skilled in the art, historical data or experimental data of other parameters can be obtained by devices like a humidity sensor, a barometric pressure sensor, and timing device.

As trained, artificial neural network 250 reflects the complex non-linear relationship between the input parameters and the output parameters, and will be stored so as to be used to predict corresponding input data according to the required output data (and possibly, some input data).

Returning to FIG. 2, the eligible environmental parameter determining component 202 is configured to determine at least one set of eligible environmental parameters that satisfy the cooling demand of the at least one rack 101 of data center 100 containing electronic devices.

According to an embodiment of the present invention, the at least one set of eligible environmental parameters include the cooling air temperature and cooling air flow speed at the inlet of each rack 101. As known by those skilled in the art, the cooling demand of a rack 101 depends on the total power consumption of the electronic devices contained in the rack 101. According to the industry cooling standard, ASHRAE 2008 (the standard by the American Society of Heating, Refrigerating, and Air-Conditioning Engineers, 2008), each 1 kW heat dissipation by an electronic device requires 150 CFM (cubic feet per minute) of cold air with a temperature equal to or lower than 27° C. Therefore, the eligible environmental parameter determining component 202 can assume that the air temperature at the rack inlet is 27° C., and multiply the power consumption of a given rack 101 (i.e., the total power consumption of the electronic devices contained in that rack 101) by 150 to get the air flow speed (in the unit of CFM) required at the inlet of that rack 101. Of course, the eligible environmental parameter determining component 202 can also assume the air temperature at the rack inlet is a temperature lower than 27° C., and calculate the air flow speed at the inlet of each rack according to the corresponding industry cooling standard and the power consumption of the each rack. In this way, the eligible environmental parameter determining component 202 can determine a set of eligible environmental parameters for each rack, which includes a certain temperature value equal to or lower than 27° C. and an air flow speed value. Alternatively, plural sets of eligible environmental parameters can be determined for each rack 101, where each set of eligible environmental parameters includes a certain temperature value equal to or lower than 27° C. and a corresponding air flow speed value.

According to an embodiment of the present invention, the eligible environmental parameter determining component 202 determines at least one set of eligible environmental parameters that satisfy the cooling demand of the at least one rack 101 containing electronic devices in response to detecting change of the power consumption of the at least one rack 101. In other words, each time a change of the power consumption of the rack 101 due to change of the load on its electronic devices is detected by the rack controller 230, for example, the eligible environment determining component 202 can determine at least one set of new eligible environmental parameters that satisfy the new cooling demand to which the new power consumption corresponds so as to adjust the setting parameters of DCAC 220. In this way, the data center energy saving control system 200 according to an embodiment of the present invention can monitor and respond to changes of the load and power consumption in rack 101 in real-time, so as to be able to realize energy saving of DCAC 200 while satisfying the cooling demand of the data center 100 in a more timely and effective manner.

As described above, in some embodiments of the present invention, the input of artificial neural network 250 further includes other parameters like the atmospheric temperature, atmospheric humidity, barometric pressure, angle of sun light, time of day etc. In these embodiments, the eligible environmental parameter determining component 202 determines the at least one set of eligible environmental parameters that satisfy the cooling demand of the at least one rack 101 not only in response to detecting a change in the power consumption of the at least one rack 101, but also in response to monitoring changes of other parameters. With the at least one set of eligible environmental parameters, eligible environmental parameter determining component 202 starts a subsequent process to adjust the setting parameters of DCAC 220 in accordance with the changes of the other parameters in real time.

Now returning to FIG. 2, air conditioner setting parameter determining component 203 is configured to, according to the set of eligible environmental parameters and the corresponding relationships between sets of the setting parameters of DCAC 200 and corresponding sets of environmental parameters, determine plural sets of setting parameters of DCAC 220, wherein the corresponding relationships are corresponding relationships based on trained artificial neural network 250.

In some embodiments of the present invention, trained artificial neural network 250 reflects the relationships between the setting parameter of DCAC 220 as its input and the environmental parameters as its output, and thus the set of eligible environmental parameters can be used as the output of trained artificial neural network 250 to obtain all the inputs that can be used to get the output (i.e., all the sets of setting parameters of DCAC 220 that can generate the set of eligible environmental parameters). Specifically, first one can traverse all the valid sets of setting parameters of DCAC 220 in a proper step (e.g., the minimum changes of the setting parameters of DCAC 220), for example, by traversing all the valid set temperatures of each air conditioning device 102 in DCAC 220 in a step of 0.5° C., and by traversing all the valid air flow volumes of each air conditioning device 102 in a step of the minimum change of the air flow volume of each air conditioning device 102. Using each set of setting parameters thus formed as the input of trained artificial neural network 250, trained artificial neural network 250 establishes a corresponding relationship between each set of valid setting parameters of DCAC 220 and the corresponding set of environmental parameters and stores the corresponding relationships. As known by those skilled in the art, the process of calculating the output of a trained artificial neural network 250 from its input is simple and rapid. In addition, because the above calculation process is performed based on the trained artificial neural network 250 as well as the theoretical setting parameters of DCAC 220 and does not need any actual measurement data, the calculation process can be performed quickly in advance, and the relationship between each set of valid parameters of DCAC 220 and the corresponding environmental parameters generated in the calculation process can be stored (e.g., in the form of a table). Thus, in response to receiving the at least one set of eligible environmental parameters, air conditioner setting parameter determining component 203 can quickly determine the plural sets of setting parameters of DCAC 220 that can generate the at least one set of eligible environmental parameters by looking up the sets of setting parameters in the table.

In some embodiments of the present invention, the input of artificial neural network 250 includes, in addition to the set of setting parameters of DCAC 220, the power consumption of each rack 101 or each set of racks 101. In such embodiments, the air conditioning set parameter determining component 203 will first obtain the current power consumption of each rack 101 or each set of the racks 101 and calculate plural sets of the setting parameters of DCAC 220 according to the current power consumption of each rack 101 or each set of the racks 101 and the set of eligible environmental parameters utilizing trained artificial neural network 250. That is, because trained artificial neural network 250 reflects the relationships between the setting parameters of DCAC 220 and the current power consumption of each rack 101 or each set of racks 101 as its input, and the environmental parameters as its output, the eligible environmental parameters can be used as the output of trained artificial neural network 250, and the current power consumption of each rack 101 or each set of racks 101 can be used as part of the inputs of trained artificial neural network 250. With these inputs and outputs, artificial neural network 250 can calculate all the valid inputs which can be used together with the part of inputs to get the output, i.e., all the sets of setting parameters of DCAC 220 that can generate the set of eligible environmental parameters under the current power consumption of each rack 101 or each set of racks 101. The corresponding relationships between each set of valid setting parameters of DCAC 220, each power consumption of a rack 101 or set of racks 101, and the corresponding set of environmental parameters can be built in advance utilizing trained artificial neural network 250, and can be stored, e.g., in the form of a table. In response to the received eligible environmental parameters and the current power consumption of each rack 101 or each set of the racks 101, plural sets of setting parameters of DCAC 220 that can generate the eligible environmental parameters and correspond to the current power consumption of each rack 101 or each set of racks 101 can quickly be found out by looking up the setting parameters in the table.

In some other embodiments of the present invention, the inputs of artificial neural network 250 include, besides a set of setting parameters of DCAC 220 (and possibly, the power consumption of each rack or each set of racks), other parameters like the atmospheric temperature, barometric pressure, atmospheric humidity, angle of sun light and time of day. In such embodiments, the corresponding relationships between each set of valid setting parameters of DCAC 220, the other parameters, and the set of corresponding environmental parameters can be established in advance according to trained artificial neural network 250 and can be stored, e.g., in the form of a table. Thus, in response to receiving the at least one set of eligible environmental parameters, air conditioner setting parameter determining component 203 can first obtain the current values of the other parameters from respective sensors and calculate plural sets of the setting parameters of DCAC 220.

Alternatively, in some other embodiment of the present invention, trained artificial neural network 250 reflects the relationships between the environmental parameters as its input and the setting parameters of DCAC 220 as its output. In such embodiments, the air conditioning setting parameter determining component 203 can use the determined set of eligible environmental parameters as the input of artificial neural network 250 to directly calculate plural sets of setting parameters of DCAC 220 as the output of artificial neural network 250. In a further embodiment of the present invention, the inputs of artificial neural network 250 may further include the power consumption of each rack 101 or each set of racks 101, and/or other parameters like the atmospheric temperature, barometric pressure, atmospheric humidity, angle of sun light and time of day. In such embodiments, air conditioner setting parameter determining component 203 can use the determined set of eligible environmental parameters and the power consumption of each rack 101 or each set of racks 101 and/or the other parameters as the input of artificial neural network 250 to directly calculate the plural sets of setting parameters of DCAC 220 as the output of the artificial neural network.

Now returning to FIG. 2, the air conditioner power consumption obtaining component 204 is configured to obtain the power consumption of DCAC 220 to which the plural sets of setting parameters determined by the air conditioner setting parameter determining component 203 correspond. Air conditioner power consumption obtaining component 204 can obtain the power consumption of DCAC 220 to which each set of setting parameters in the plural sets of setting parameters corresponds, or get the power consumption of DCAC 220 to which some sets of setting parameters in the plural sets of setting parameters of DCAC 220 corresponds. As known by those skilled in the art, different setting parameters of DCAC 220 correspond to different power consumptions. For example, the power consumption of DCAC 220 is reduced with the increase of the set temperature (e.g., every increase in set temperature by 1° C. will reduce power consumption by 3.8% for a DCAC 220 that cools by direct compression and by 3% for a DCAC 220 that cools by central chilled water), is increased with an increase of air flow volumes (at low speed, the relationship between the air flow volume and the power consumption is usually linear), and is increased with an increase of the speed of the air-supply fan (the power consumption of an air conditioning device 102 is approximately directly proportional to the third power of the rotation speed of the air-supply fan). The corresponding relationships between the setting parameters of a DCAC 220 and its power consumption are usually provided by the manufacturer of DCAC 220 or can be obtained through data collection. The air conditioner power consumption obtaining component 204 can thus calculate (e.g., according to the corresponding relationships between the setting parameters of DCAC 220 and its power consumption provided by the manufacturer of DCAC 220) the power consumption to which each set of setting parameters of DCAC 220 that are determined by the air conditioner parameter determining component 203 corresponds.

Data center energy saving control system 200 further includes selecting and setting component 205, which is configured to select a set of setting parameters of which the corresponding power consumption satisfies a predetermined condition for energy saving and to set the operating point of DCAC 220 using the set of setting parameters. In other words, selecting and setting component 205 can select a set of setting parameters of which the corresponding power consumption satisfies a predetermined condition for energy saving according to the different power consumptions to which the plural sets of setting parameters of DCAC 220 correspond and which are obtained by the air conditioner power consumption obtaining component 203, and uses the set of setting parameters to set DCAC 220. For example, the selecting and setting component 205 can select, from plural sets of set temperatures and air flow volumes of DCAC 220 that can generate eligible environmental parameters and are determined by the air conditioner setting parameter determining component 203, a set of set temperatures and air flow volumes having total power consumptions satisfying the predetermined condition for energy saving, and then use the selected set of set temperature and air flow volume to set DCAC 220.

According to an embodiment of the present invention, the predetermined condition can be the minimum power consumption in the power consumptions to which the plural sets of setting parameters of DCAC 220 correspond. Thus, selecting and setting component 205 will select, from the plural sets of setting parameters of DCAC 220 determined by air conditioner setting parameter determining component 203, a set of setting parameters having a minimum power consumption and use the set of setting parameters to set DCAC 220.

According to another embodiment of the present invention, the predetermined condition can be a relatively lower power consumption among the power consumptions to which the plural sets of setting parameters of DCAC 220 correspond, e.g., a power consumption smaller than the maximum power consumption in the power consumptions to which the plural sets of setting parameters of DCAC 220 correspond; or further, a power consumption smaller than the maximum power consumption by a predetermined proportion. Thus, the selecting and setting component 205 will select, from the plural sets of setting parameters of DCAC 220 determined by the air conditioner setting parameter determining component 203, a set of setting parameters of which the corresponding power consumption is relatively small and will use the set of setting parameters to set DCAC 220.

According to yet another embodiment of the present invention, the predetermined condition may be a power consumption smaller than a predetermined value. Thus, selecting and setting component 205 will select, from the plural sets of setting parameters of DCAC 220 determined by the air conditioner setting parameter determining component 203, a set of setting parameters for which the corresponding power consumption is smaller than the predetermined value and will use the set of setting parameters to set DCAC 220.

As known by those skilled in the art, DCAC 220 can usually be set by receiving and executing commands for setting its parameters, and thus, selecting and setting component 205 can set DCAC 220 by sending commands for setting its parameters to DCAC 220. Of course, selecting and setting component 205 can also present the selected set of setting parameters to a human administrator, who can manually set DCAC 220 according to the setting parameters.

A data center energy saving control system 200 according to an embodiment of the present invention has been described with reference to the accompanying drawings. The foregoing description is only exemplary of the present invention and should not be construed as limiting the present invention. In other embodiments of the present invention, the system may have more, less or different components, and the containment, connection and functional relationships between these component may be different from that is described and illustrated. For example, in some embodiments of the present invention, the system may further comprise environmental parameter monitoring system 210. As a further example, in some embodiments of the present invention, selecting and setting component 205 can be divided into a separate air conditioner setting parameters selecting component and an air conditioner setting component. As a still further example, in some other embodiments of the present invention, eligible environmental parameter determining component 202, air conditioner setting parameter determining component 203, air conditioner power consumption obtaining component 204 and selecting and setting component 205 may be merged into a single air conditioner setting component. All such changes are within the spirit and scope of the present invention.

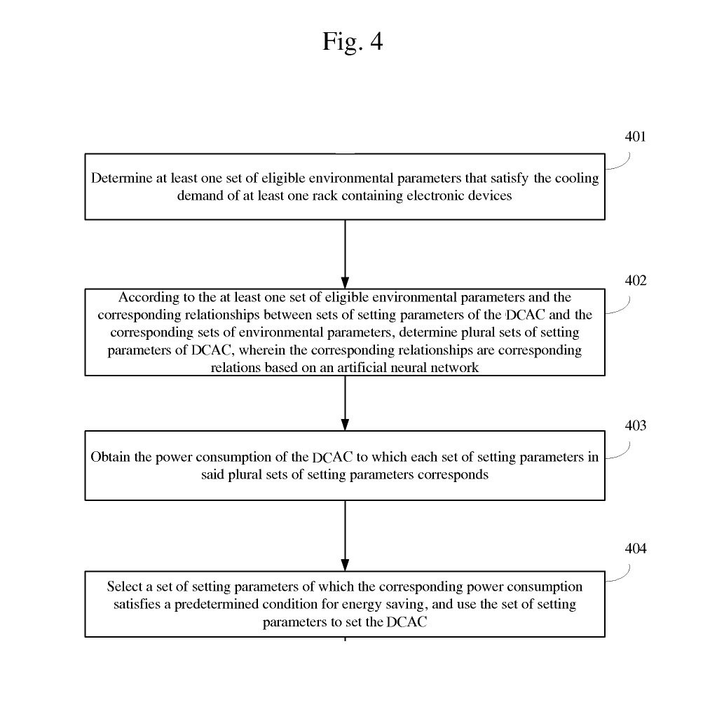

Referring now to FIG. 4, a data center energy saving control method according to an embodiment of the present invention is now described. The described method can be executed by the above data center energy saving control system 200 to provide energy savings in the operation of data center 100 according to an embodiment of the present invention. For simplicity, certain details of the method previously described are omitted in the following description. Therefore, the described data center energy saving control method can be better understood by referring to the above description.

At step 401, data center energy saving control system 200 determines at least one set of eligible environmental parameters that satisfy cooling demand of the at least one rack 101 containing electronic devices. At step 402, according to the at least one set of eligible environmental parameters and the corresponding relationships between sets of setting parameters of DCAC 220 and corresponding sets of environmental parameters, data center energy saving control system 200 determines plural sets of setting parameters of DCAC 220, wherein the corresponding relationships are determined based on artificial neural network 250. At step 403, data center energy saving control system 200 obtains power consumptions of DCAC 220 to which the plural sets of setting parameters of DCAC correspond. At step 404, data center energy saving control system 200 selects a set of setting parameters for which the corresponding power consumption satisfies a predetermined condition for energy saving and uses the set of setting parameters to set DCAC 220.

The above method is only an exemplary illustration of the present invention, not a limitation to the present invention. In other embodiments, the method may have more, less or different steps, and the relationships of sequence and containment between the steps may be different from that is described and illustrated.

According to an embodiment of the present invention, the predetermined condition is the minimum power consumption in the power consumptions of DCAC 220 to which the plural sets of setting parameters correspond. According to another embodiment of the present invention, the predetermined condition is a relatively smaller power consumption among the power consumptions to which the plural sets of setting parameters of DCAC correspond. According to still another embodiment of the present invention, the predetermined condition is a power consumption smaller than a predetermined value.

According to some embodiments of the present invention, artificial neural network 250 is obtained by training using experimental data or historical data of a set of setting parameters of DCAC as the input data and using experimental data or historical data of a set of environmental parameters monitored by the environmental parameter monitoring system as the output data.

According to a further embodiment of the present invention, the method further comprises the following steps: traversing all the valid sets of setting parameters of DCAC 220 in a specified step and using each valid set of setting parameters as the input of the artificial neural network and using trained artificial neural network 250 to calculate a corresponding set of environmental parameters as the output of the artificial neural network, so as to get the corresponding relationships between sets of setting parameters of DCAC 220 and corresponding sets of environmental parameters.

According to some other embodiments of the present invention, artificial neural network 250 is obtained by training using experimental data or historical data of a set of environmental parameters monitored by the environmental parameter monitoring system as the input data and using experimental data or historical data of a set of setting parameters of DCAC 220 as the output data.

According to an embodiment of the present invention, the setting parameters of DCAC 220 include the set temperature and air flow volume of DCAC 220, and the environmental parameters include the monitored environmental temperature and air flow speed.

According to an embodiment of the present invention, environmental parameter monitoring system 210 includes a temperature sensor and an air flow sensor at the inlet of each rack 101 of data center 100.

According to an embodiment of the present invention, the input data for training artificial neural network 250 further includes experimental data or historical data of the power consumption in each set of one or more racks 101, and the calculation of the plural sets of setting parameters of DCAC 220 is further based on the current power consumption of each set of one or more racks 101. According to an embodiment of the present invention, the input data for training artificial neural network 250 further includes the atmospheric temperature and the calculation of the plural sets of setting parameters of DCAC 220 is further based on the current atmospheric temperature.

According to an embodiment of the present invention, the determination of at least one set of eligible environmental parameters that satisfies the cooling demand of the at least one rack 101 is performed in response to detecting a change in the power consumption of the at least one rack 101.

The present invention can be realized in hardware, software, or a combination thereof. The present invention can be realized in a computer system in a centralized manner or in a distributed manner in which different components are distributed in some interconnected computer system. Any computer system or other devices suitable for executing the method described herein are appropriate. A typical combination of hardware and software can be a computer system with a computer program, which when being loaded and executed, controls the computer system to execute the method of the present invention and constitute the apparatus of the present invention. The present invention can also be embodied in a computer program product including a computer-readable storage medium (e.g., ROM, CD-ROM, DVD, memory, optical or magnetic disk, flash drive, etc.) storing program code that can realize the features described herein, and when being loaded into a computer system, can execute the described method.

Although the present invention has been illustrated and described with reference to the preferred embodiments, those skilled in the art will understand that various changes both in form and detail may be made thereto without departing from the spirit and scope of the present invention. Therefore, the described aspects, features, embodiments and advantages are only illustrative, rather than elements or limitations of the appended claims, unless explicitly stated otherwise in the claims.

1. A data center energy saving control method for a data center including at least one rack containing electronic devices, a data center air conditioning system (DCAC), and an environmental parameter monitoring system, the method comprising:
determining at least one set of eligible environmental parameters that satisfies the cooling demand of the at least one rack containing electronic devices;
according to the at least one set of eligible environmental parameters and corresponding relationships between sets of setting parameters of the DCAC and corresponding sets of environmental parameters, determining plural sets of setting parameters of the DCAC, wherein the corresponding relationships are determined by an artificial neural network;
obtaining a power consumption of the DCAC to which each set of setting parameters in the plural sets of setting parameters corresponds; and
selecting a set of setting parameters for which the corresponding power consumption satisfies a predetermined condition for energy saving and using the set of setting parameters to set the DCAC.

2. The method of claim 1, and further comprising:
training the artificial neural network using data of a set of setting parameters of the DCAC as the input data and using data of a set of environmental parameters monitored by the environmental parameter monitoring system as the output data.

3. The method of claim 2, wherein the setting parameters for training the artificial neural network further include at least one of a set including:
an atmospheric temperature; and
power consumption data of each of multiple sets of one or more racks in the data center.

4. The method of claim 1, further comprising:
obtaining corresponding relationships between the sets of setting parameters of the DCAC and sets of environmental parameters by taking each valid set of setting parameters as an input of the artificial neural network and calculating a corresponding set of environmental parameters as the output of the artificial neural network.

5. The method of claim 1, and further comprising:
training the artificial neural network using data of the set of environmental parameters monitored by the environmental parameter monitoring system as input data and using data of the set of setting parameters of DCAC as output data.

6. The method of claim 1, wherein:
the setting parameters of the DCAC include the set temperature and air flow volume of the DCAC; and
the environmental parameters include the monitored environment temperature and air flow speed.

7. The method of claim 1, wherein determining at least one set of eligible environmental parameters that satisfy cooling demand of the at least one rack is performed in response to detecting a change in power consumption of the at least one rack.

8. A data processing system for controlling cooling of a data center including at least one rack containing electronic devices, a data center air conditioning system (DCAC), and an environmental parameter monitoring system, the data processing system comprising:
a processor;
data storage coupled to the processor; and
program code within the data storage and executable by the processor to cause the data processing system to perform:
determining at least one set of eligible environmental parameters that satisfies the cooling demand of the at least one rack containing electronic devices;
according to the at least one set of eligible environmental parameters and corresponding relationships between sets of setting parameters of the DCAC and corresponding sets of environmental parameters, determining plural sets of setting parameters of the DCAC, wherein the corresponding relationships are determined by an artificial neural network;
obtaining a power consumption of the DCAC to which each set of setting parameters in the plural sets of setting parameters corresponds; and
selecting a set of setting parameters for which the corresponding power consumption satisfies a predetermined condition for energy saving and using the set of setting parameters to set the DCAC.

9. The data processing system of claim 8, wherein the program code further causes the data processing system to perform:
training the artificial neural network using data of a set of setting parameters of the DCAC as the input data and using data of a set of environmental parameters monitored by the environmental parameter monitoring system as the output data.

10. The data processing system of claim 9, wherein the setting parameters for training the artificial neural network further include at least one of a set including:
an atmospheric temperature; and
power consumption data of each of multiple sets of one or more racks in the data center.

11. The data processing system of claim 8, further comprising:
obtaining corresponding relationships between the sets of setting parameters of the DCAC and sets of environmental parameters by taking each valid set of setting parameters as an input of the artificial neural network and calculating a corresponding set of environmental parameters as the output of the artificial neural network.

12. The data processing system of claim 8, wherein the program code further causes the data processing system to perform:
training the artificial neural network using data of the set of environmental parameters monitored by the environmental parameter monitoring system as input data and using data of the set of setting parameters of DCAC as output data.

13. The data processing system of claim 8, wherein:
the setting parameters of the DCAC include the set temperature and air flow volume of the DCAC; and
the environmental parameters include the monitored environment temperature and air flow speed.

14. The data processing system of claim 8, wherein the program code further causes the data processing system to perform:
receiving, from the environmental parameter monitoring system, a temperature and an air flow at an inlet of each of the at least one rack in the data center.

15. A program product for controlling cooling of a data center including at least one rack containing electronic devices, a data center air conditioning system (DCAC), and an environmental parameter monitoring system, the program product comprising:
a computer-readable storage device;
program code within the computer-readable storage device and executable by a processor of a data processing system to cause the data processing system to perform:
determining at least one set of eligible environmental parameters that satisfies the cooling demand of the at least one rack containing electronic devices;
according to the at least one set of eligible environmental parameters and corresponding relationships between sets of setting parameters of the DCAC and corresponding sets of environmental parameters, determining plural sets of setting parameters of the DCAC, wherein the corresponding relationships are determined by an artificial neural network;
obtaining a power consumption of the DCAC to which each set of setting parameters in the plural sets of setting parameters corresponds; and
selecting a set of setting parameters for which the corresponding power consumption satisfies a predetermined condition for energy saving and using the set of setting parameters to set the DCAC.

16. The program product of claim 15, wherein the program code further causes the data processing system to perform:
training the artificial neural network using data of a set of setting parameters of the DCAC as the input data and using data of a set of environmental parameters monitored by the environmental parameter monitoring system as the output data.

17. The program product of claim 16, wherein the setting parameters for training the artificial neural network further include at least one of a set including:
an atmospheric temperature; and
power consumption data of each of multiple sets of one or more racks in the data center.

18. The program product of claim 15, further comprising:
obtaining corresponding relationships between the sets of setting parameters of the DCAC and sets of environmental parameters by taking each valid set of setting parameters as an input of the artificial neural network and calculating a corresponding set of environmental parameters as the output of the artificial neural network.

19. The program product of claim 15, wherein the program code further causes the data processing system to perform:
training the artificial neural network using data of the set of environmental parameters monitored by the environmental parameter monitoring system as input data and using data of the set of setting parameters of DCAC as output data.

20. The program product of claim 15, wherein:
the setting parameters of the DCAC include the set temperature and air flow volume of the DCAC; and
the environmental parameters include the monitored environment temperature and air flow speed.
